(19) United States
(12) Patent Application Publication
(10) Pub. No.: US 2026/0253025 A1
(43) Pub. Date: Aug. 27, 2026

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/879,226

(22) PCT Filed: Jun. 28, 2023
(86) PCT No.: PCT/JP2023/024021

§ 371 Date: Dec. 26, 2024

(30) Foreign Application Priority Data
Jun. 30, 2022 (JP) 2022-105545

(51) Int. Cl. G06Q 10/0836; G06Q 10/0832

(52) U.S. Cl. CPC G06Q 10/0836; G06Q 10/0832

(57) ABSTRACT

An information processing system includes a control unit that sets a candidate for a proxy who is able to pick up a package on behalf of a recipient designated in an address of the package, as the proxy, and a communication unit that notifies the proxy or the candidate for the proxy of information about the package.

### FIELD The present invention relates to an information processing system, an information processing device, an information processing method, and a program.

### BACKGROUND

In recent years, package delivery services have come to use more and more kinds of delivery means, and technologies have been developed to handle a variety of delivery means. For example, Patent Literature 1 discloses a logistics management system that manages information about a logistics network and changes operation plans of a circular service circulating in an area on the basis of such information.

CITATION LIST

### Patent Literature

Patent Literature 1: Japanese Patent Application Laid-open No. 2020-52525

### SUMMARY

### Technical Problem

As such package delivery means, unmanned vehicles capable of autonomous control, for example unmanned aircrafts such as drones and unmanned aerial vehicles (UAVs) and travel bodies such as unmanned ground vehicles (UGVs) have come to be used. An unmanned vehicle may deliver a package to a predetermined departure and arrival point. Here, if a recipient designated in an address of the package is unable to pick up the package at the predetermined departure and arrival point, a proxy of the recipient, such as a manager of the predetermined departure and arrival point, may be considered to pick up the package. However, if the proxy does not know information about the package, he or she may not be ready to pick up the package at the pick-up.

The present invention has been made in view of the above problem, and an object of the present invention is to provide a novel and improved technology that enables a proxy, who is a representative of a recipient, to pick up a package smoothly.

### Solution to Problem

In order to solve the above problem, one aspect of the present invention provides an information processing system including: a control unit that sets a candidate for a proxy who is able to pick up a package on behalf of a recipient designated in an address of the package, as the proxy; and a communication unit that notifies the proxy or the candidate for the proxy of information about the package.

Moreover, in order to solve the above problem, another aspect of the present invention provides an information processing device including: a control unit that sets a candidate for a proxy who is able to pick up a package on behalf of a recipient designated in an address of the package, as the proxy; and a communication unit that notifies the proxy or the candidate for the proxy of information about the package.

In addition, in order to solve the above problem, still another aspect of the present invention provides an information processing method to be performed by a computer, the information processing method including: setting a candidate for a proxy who is able to pick up a package on behalf of a recipient designated in an address of the package, as the proxy; and notifying the proxy or the candidate for the proxy of information about the package.

Furthermore, in order to solve the above problem, yet another aspect of the present invention provides a program causing a computer to function as: a control unit that sets a candidate for a proxy who is able to pick up a package on behalf of a recipient designated in an address of the package, as the proxy; and a communication unit that notifies the proxy or the candidate for the proxy of information about the package.

### Advantageous Effects of Invention

As described above, the present invention enables smooth pick-up of a package by a proxy on behalf of a recipient.

### BRIEF DESCRIPTION OF DRAWINGS

FIG. 1 is an explanatory diagram of an overview of an information processing system according to the present invention.

FIG. 2 is an image diagram of package delivery in an information processing system according to the present invention.

FIG. 3 is an explanatory diagram illustrating an internal structure of a recipient's terminal 10.

FIG. 4 is an explanatory diagram illustrating an internal structure of a proxy's terminal 20.

FIG. 5 is an explanatory diagram illustrating an internal structure of a proxy management server 30.

FIG. 6 is a diagram illustrating an example of information about a package L that is stored in a storage unit 310.

FIG. 7 is a diagram illustrating an example of a notification of the information about the package L to a proxy P when the information about the package L illustrated in FIG. 6 is stored in the storage unit 310.

FIG. 8 is a diagram illustrating an example of the notification of the information about the package L to the proxy P when the information about the package L illustrated in FIG. 6 is stored in the storage unit 310.

FIG. 9 is a diagram illustrating an example of the notification of the information about the package L to a candidate C for the proxy when the information about the package L illustrated in FIG. 6 is stored in the storage unit 310.

FIG. 10 is a diagram illustrating an example of a notification of a proxy recruitment transmitted to the proxy's terminal 20.

FIG. 11 is an explanatory diagram for describing an example of a procedure of operation processing by the proxy management server 30 according to the present embodiment.

FIG. 12 is an explanatory diagram for describing an example of a hardware configuration of the proxy management server 30 according to the present embodiment.

### DESCRIPTION OF EMBODIMENTS

The contents of embodiments of the present invention will be listed and described. An information processing system and the like according to the embodiments of the present invention include the following configurations.

### Item 1

An information processing system including:
a control unit that sets a candidate for a proxy who is able to pick up a package on behalf of a recipient designated in an address of the package, as the proxy; and
a communication unit that notifies the proxy or the candidate for the proxy of information about the package.

### Item 2

The information processing system according to item 1, in which the communication unit notifies the proxy or the candidate for the proxy of an expected arrival time of the package.

### Item 3

The information processing system according to item 2, in which the communication unit notifies the proxy or the candidate for the proxy of the expected arrival time of the package according to a time slot of delivery of the package.

### Item 4

The information processing system according to any one of Items 1 to 3, in which the communication unit receives an expected arrival time of the recipient from an information processing terminal used by the recipient, and notifies the proxy of the expected arrival time.

### Item 5

The information processing system according to any one of Items 1 to 3, in which in a case where the package picked up by the proxy is delivered to the recipient by a delivery person, the communication unit notifies the proxy or the candidate for the proxy of an expected arrival time of the delivery person.

### Item 6

The information processing system according to any one of Items 1 to 3, in which the communication unit notifies the proxy or the candidate for the proxy of whether the package is a frozen commodity.

### Item 7

The information processing system according to any one of Items 1 to 3, in which the communication unit notifies the proxy or the candidate for the proxy of whether the package is a commodity that needs to be handled with care.

### Item 8

The information processing system according to item 7, in which the commodity that needs to be handled with care is at least any of “this side up”, “do not stack”, “perishable item”, or “fragile”.

### Item 9

The information processing system according to any one of Items 1 to 3, in which the communication unit notifies the proxy of a delivery means of the package.

### Item 10

The information processing system according to item 9, in which the communication unit notifies the proxy of an instruction of preparation in accordance with the delivery means of the package.

### Item 11

The information processing system according to item 10, in which in a case where the delivery means of the package is an unmanned vehicle, the communication unit notifies the proxy to perform landing preparation of the unmanned vehicle.

### Item 12

The information processing system according to any one of Items 1 to 3, in which the communication unit receives a notification as to whether pick-up of the package is possible, from an information processing terminal used by the candidate for the proxy.

### Item 13

The information processing system according to item 12, in which when the communication unit receives a notification that the pick-up of the package is impossible from the information processing terminal used by the candidate for the proxy, the communication unit transmits a proxy recruitment for package pick-up to a candidate for the proxy who is different from the candidate for the proxy.

### Item 14

The information processing system according to item 13, in which in a case where setting of the proxy who is able to pick up the package is impossible, the communication unit notifies the recipient that the delivery of the package is impossible.

### Item 15

The information processing system according to item 13, in which in a case where setting of the proxy who is able to pick up the package is impossible, the communication unit notifies the recipient to reset the time slot of the delivery of the package.

### Item 16

An information processing device including:
a control unit that sets a candidate for a proxy who is able to pick up a package on behalf of a recipient designated in an address of the package, as the proxy; and
a communication unit that notifies the proxy or the candidate for the proxy of information about the package.

### Item 17

An information processing method to be performed by a computer, the information processing method including:
setting a candidate for a proxy who is able to pick up a package on behalf of a recipient designated in an address of the package, as the proxy; and
notifying the proxy or the candidate for the proxy of information about the package.

### Item 18

A program causing a computer to function as:
a control unit that sets a candidate for a proxy who is able to pick up a package on behalf of a recipient designated in an address of the package, as the proxy; and
a communication unit that notifies the proxy or the candidate for the proxy of information about the package.

Preferred embodiments of the present invention will hereinafter be described in detail with reference to the accompanying drawings. In the present specification and drawings, duplicate explanations of components having substantially identical functional configuration will be omitted by applying the same reference signs thereto.

In the present specification and the drawings, a plurality of components with substantially the same functional configuration may be distinguished by the same reference sign followed by different alphabets or numerals. However, when there is no particular need to distinguish between the components that have substantially the same functional configuration, just the same reference sign is given to each of the components.

### 1. Overview of Information Processing System According to One Embodiment of Present Disclosure

First, an overview of an information processing system in the embodiment of the present invention is described.

This information processing system enables a proxy, who is a representative of a recipient, to pick up a package smoothly.

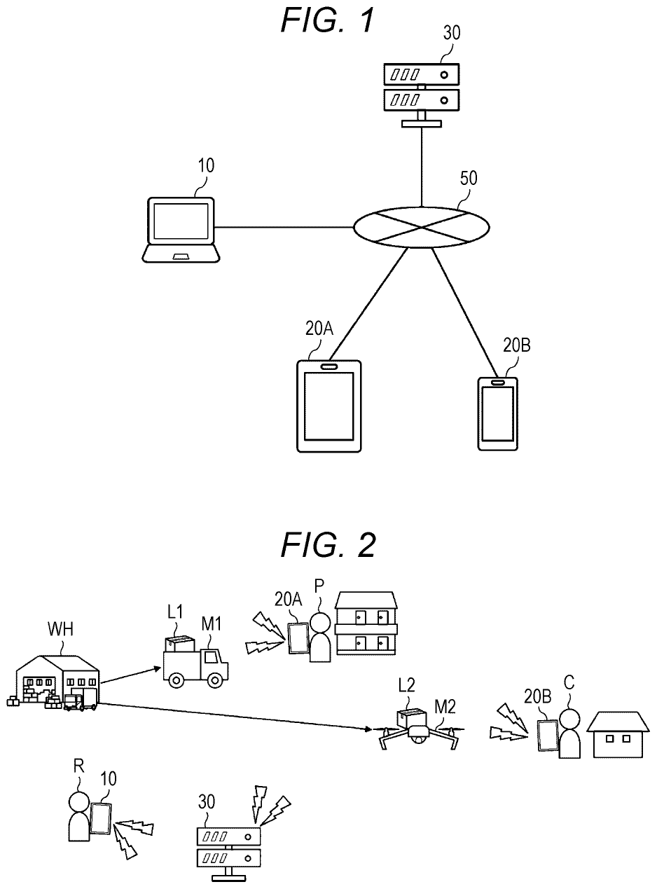

FIG. 1 is an explanatory diagram of an overview of the information processing system according to the present invention. As illustrated in FIG. 1, the information processing system according to the present invention includes a recipient's terminal 10, a proxy's terminal 20, a proxy management server 30, and a network 50. As illustrated in FIG. 1, the recipient's terminal 10, the proxy's terminal 20, and the proxy management server 30 are configured to be able to communicate with each other via the network 50.

The recipient's terminal 10 is an information processing terminal used by the recipient designated in an address of the package. The package of the recipient may also be picked up once and then kept by a proxy, such as a package manager who manages the package. The package manager may be an employee of a store, such as a convenience store, a manager of a departure and arrival point for a mobile body that delivers packages, or the like and can be a person linked to a pick-up position that is set according to the recipient's address or according to the recipient's designating operation. Instead of, or in addition to the case in which the proxy is determined in advance in this manner, the recipient's terminal 10 may transmit designation information, which is the designation of a candidate for a proxy who can pick up the package on behalf of the recipient, to the proxy management server 30. The recipient, for example, may designate a specific person as the candidate for the proxy. This allows the recipient to ask the designated specific person to pick up the package on his/her behalf. The specific person is desirably a suitable person to pick up the package on behalf of the recipient, for example, a family member, a friend, a manager in charge of a departure and arrival point for a mobile body that delivers the package, or an organizer of a neighborhood association. The designation information may be information that designates the type of the candidate for the proxy or may be information that represents the identification information of a specific candidate for the proxy.

The recipient's terminal 10 also transmits a proxy support request to the proxy management server 30, requesting the person indicated in the designation information to support the package pick-up by proxy. The recipient can have the proxy management server 30 recruit a proxy, that is, recruit a person who contracts for the pick-up of the package on behalf of the recipient as a one-off job by transmitting the proxy support request. The proxy support request may be transmitted simultaneously to the persons indicated in the designation information with reference to the designation information, or may be transmitted for each proxy candidate type in the order indicated by priority order information, which is related to the designation information and set in advance by the recipient, with reference to the priority order information. If the proxy support request is transmitted in order for each proxy candidate type, the proxy support request may be transmitted sequentially each time a predetermined deadline period elapses. The deadline period information may be set individually for each proxy candidate type, or may be set in common.

The proxy's terminal 20 is an information processing terminal used by the candidate for the proxy, or the proxy. The proxy's terminal 20 receives a proxy request to ask for the pick-up of the package by proxy, a notification of the proxy recruitment, and a notification of setting the proxy from the proxy management server 30. The proxy's terminal 20 also receives the information about the package from the proxy management server 30. In addition, the proxy's terminal 20 transmits a notification to the proxy management server 30 as to whether the proxy pick-up of the package is possible by an approval operation on the application, etc.

The recipient's terminal 10 and the proxy's terminal 20 are, for example, information processing terminals such as a personal computer, a tablet terminal, a smartphone, a cellular phone, a personal handy-phone system (PHS), and a personal digital assistant (PDA). In the example illustrated in FIG. 1, the recipient's terminal 10 is a personal computer, a proxy's terminal 20A is a tablet terminal, and a proxy's terminal 20B is a smartphone.

The proxy management server 30 is an example of an information processing device. The proxy management server 30 is a server that sets a candidate for a proxy who can pick up a package on behalf of the recipient designated in the address of the package, as the proxy, and notifies the candidate for the proxy or the proxy of various kinds of information about the package. For example, the proxy management server 30 may be a general-purpose computer, such as a workstation or PC, or may be a cloud server.

Upon the reception of the designation information, which is the designation of the candidate for the proxy from the recipient's terminal 10 (or with reference to the previously received designation information), the proxy management server 30 transmits a proxy request to the proxy's terminal 20 used by that candidate for the proxy.

In addition, upon the reception of the proxy support request from the recipient's terminal 10 or in accordance with the information about the package, the proxy management server 30 selects the candidate for the proxy. Subsequently, the proxy management server 30 transmits the notification of the proxy recruitment to the proxy's terminal 20 used by the selected candidate for the proxy. Upon the reception of the notification from the proxy's terminal 20 that the proxy pick-up of the package is possible, the proxy management server 30 sets the candidate for the proxy who uses that proxy's terminal 20, as the proxy. The proxy management server 30 may also transmit the proxy request and the notification of the proxy recruitment on the basis of the information about the package to be delivered. The proxy management server 30 may also set the proxy on the basis of the information about the package to be delivered.

The network 50 is a wired or wireless transmission path for information transmitted from devices connected to the network 50. For example, the network 50 may include a public network such as the Internet, a telephone network, or a satellite communication network, various local area networks (LANs) including Ethernet (registered trademark), or a wide area network (WAN). The network 50 may also include a leased line network such as Internet protocol-virtual private network (IP-VPN).

FIG. 2 is an image diagram of the package delivery in the information processing system according to the present invention. In the example illustrated in FIG. 2, a recipient R, who is designated in an address of a package L1 to be delivered by a mobile body Ml from a warehouse WH where the packages L are kept, and a package L2 to be delivered by a mobile body M2 from the warehouse WH, asks someone to pick up the packages L1 and L2 on behalf of the recipient. The warehouse WH may be replaced by a retail store, a restaurant, or the like.

In FIG. 2, the mobile body Ml is a truck and the mobile body M2 is an unmanned vehicle; however, the means of delivery of the package L is not limited to these. For example, the mobile body M may be a manned mobile body such as a vehicle that moves in a land route (for example, a passenger car, a cargo vehicle such as a small truck or van, a motorbike, a bicycle, a scooter, or the like), an aircraft that flies in an air route, or a ship that moves in a water route such as a sea route or a river route.

The mobile body M may be an unmanned vehicle that moves based on autonomous control using input information about positions, for example, two positions of a start point (for example, a delivery start position of the package L or a moving start position of an unmanned vehicle 10B) and an end point (for example, a pick-up position of the package L), or three or more positions of further including a relay point (for example, in a case of delivery with collection of the package L, a collection position of the package L) or a return point (for example, the same position as the moving start position of the unmanned vehicle 10, or a different stand-by position, etc.). The mobile body M may be an unmanned vehicle that moves by a remote operation using operation information remotely operated and input by a manager who manages the unmanned vehicle. The unmanned vehicle may be, for example, a drone that moves based on autonomous control, an unmanned aerial vehicle (UAV) that moves by a remote operation by a manager, a vehicle that moves in a land route, such as an unmanned ground vehicle (UGV), or a ship that moves in a water route such as a sea route or a river route. The unmanned vehicle may alternatively be a mobile body that can move in at least two or more routes of a land route, a water route, and an air route.

A proxy P, who is set to be able to pick up the package L1 on behalf of the recipient R who uses the recipient's terminal 10, receives a notification of information about the package L1 from the proxy management server 30 via the proxy's terminal 20. In addition, by the proxy management server 30, a candidate C for the proxy, who can pick up the package L2 on behalf of the recipient R who uses the recipient's terminal 10, receives a notification of the information about the package L2 via the proxy's terminal 20.

### 2. Example of Functional Configuration in Present Embodiment

### <2-1. Example of Functional Configuration of Recipient's Terminal 10>

The overview of the information processing system according to the embodiment of the invention has been described above. Next, an example of the functional configuration of the recipient's terminal 10 is described.

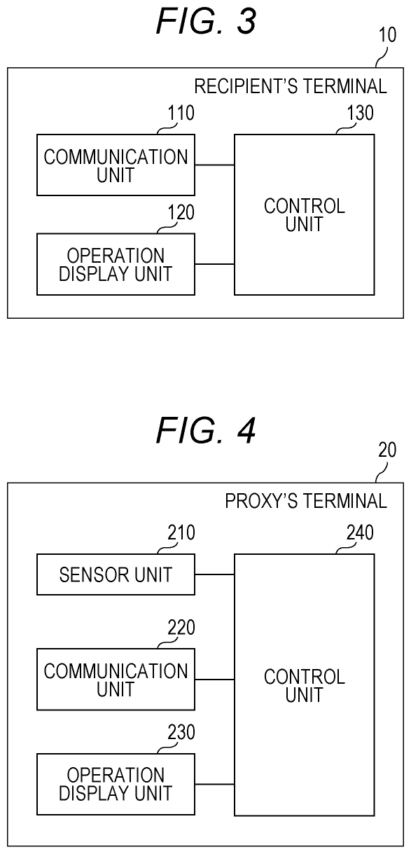

FIG. 3 is an explanatory diagram illustrating an internal structure of the recipient's terminal 10. As illustrated in FIG. 3, the recipient's terminal 10 includes a communication unit 110, an operation display unit 120, and a control unit 130.

### (Communication Unit)

The communication unit 110 communicates with and connects to the proxy management server 30 via the network 50 and transmits and receives data. For example, the communication unit 110 may transmit a delivery request of the package L to the proxy management server 30 on the basis of the operation of the operation display unit 120 by the recipient R. The delivery request can include various requests, such as a time slot of the delivery by the mobile body M and the pick-up position of the package L. The time slot of the delivery (hereinafter also referred to as “delivery slot”) is the time slot in which the mobile body M (or a delivery person who delivers the package L by using the mobile body M) responds to the delivery request. For example, a daily delivery plan for the unmanned vehicle M (or delivery person) is sectioned for every predetermined delivery slot (for example, 15 to 30 minutes for the unmanned vehicle and one hour for the delivery person) and the unmanned vehicle M (or delivery person) delivers the packages L registered in every delivery slot in the time expressed by that delivery slot. In the delivery slot of the unmanned vehicle M, for example, the packages to one or two destinations may be registered and in the delivery slot of the delivery person, the packages to a number of destinations, for example five to ten destinations, may be registered; however, the present invention is not limited to this example. The delivery plan and the delivery slot may be set for each of a plurality of potential pick-up positions.

Moreover, the communication unit 110 transmits the proxy support request and the designation information, which is the designation of the candidate C for the proxy about the package L, to the proxy management server 30.

The communication unit 110 also receives from the proxy management server 30, a notification as to whether the package L can be delivered and the setting status of the proxy P regarding the package L where the recipient R is designated in the address.

### (Operation Display Unit)

The operation display unit 120 encompasses a function as an operation unit, which is a structure that the recipient R operates to input an instruction or information into the recipient's terminal 10, and a function as a display unit, which displays various kinds of information according to the control by the control unit 130. For example, by operating the operation display unit 120, the recipient R causes the communication unit 110 to transmit the delivery request, the designation information, and the proxy support request to the proxy management server 30.

By operating the operation display unit 120, the recipient R may designate, for each package L, the candidate C for the proxy about that package L. The recipient R may also set one or more candidates C for the proxy in advance by operating the operation display unit 120. In such a case, the recipient R may operate the operation display unit 120 so as to cause the communication unit 110 to transmit a notification to the proxy management server 30 to designate the preset one or more candidates C for the proxy as the candidate or candidates C for the proxy about the package L. This eliminates the complexity for the recipient R to designate the candidate C for the proxy for each package L. The recipient R may also operate the operation display unit 120 to designate the candidate or candidates C for the proxy about the package L by selecting a part of the preset candidates C for the proxy. Note that when the candidate C for the proxy is the package manager who manages the package, a person who is linked to the pick-up position set in accordance with the address of the recipient R not via the designation information from the recipient R or in accordance with the designating operation of the recipient R may be selected as the candidate C for the proxy, the present information system may be a system with this configuration only, or the present information system may be a system combining the designation of the candidate C for the proxy by the recipient R.

By operating the operation display unit 120, the recipient R may designate the expected arrival time of the recipient R when picking up the package L that is picked up and kept by the proxy P, and cause the communication unit 110 to transmit the information to the proxy management server 30.

The operation display unit 120 displays the information transmitted from the proxy management server 30 to the communication unit 110, such as the notification as to whether the delivery of the package L is possible and the setting status of the proxy P.

### (Control Unit)

The Control Unit 130 Controls the Overall Operation of the recipient's terminal 10. For example, the control unit 130 causes the communication unit 110 to transmit the delivery request, the designation information, and the proxy support request acquired by the operation display unit 120. The control unit 130 causes the operation display unit 120 to display the setting status of the proxy P and the notification as to whether the delivery of the package L is possible that are received from the proxy management server 30 by the communication unit 110.

### <2-2. Example of Functional Configuration of Proxy's Terminal 20>

The example of the functional configuration of the recipient's terminal 10 according to the embodiment of the present invention has been described above. Subsequently, an example of the functional configuration of the proxy's terminal 20 is described.

FIG. 4 is an explanatory diagram illustrating an internal structure of the proxy's terminal 20. As illustrated in FIG. 4, the proxy's terminal 20 includes a sensor unit 210, a communication unit 220, an operation display unit 230, and a control unit 240.

### (Sensor Unit)

The sensor unit 210 is a sensor that detects the current position of the proxy's terminal 20. The sensor unit 210 may detect the current position of the proxy's terminal 20 using a global navigation satellite system (GNSS), for example.

### (Communication Unit)

The communication unit 220 communicates with and connects to the proxy management server 30 via the network 50 and transmits and receives data. The communication unit 220 receives the information about the package L from the proxy management server 30. The communication unit 220 receives from the proxy management server 30, the proxy request to ask for the proxy pick-up of the package L, the notification of the proxy recruitment, and the notification of setting of the proxy P.

The communication unit 220 notifies the proxy management server 30 of whether the proxy pick-up of the package L input in the operation display unit 230 is possible. The communication unit 220 transmits the positional information of the proxy's terminal 20 acquired by the sensor unit 210 to the proxy management server 30.

### (Operation Display Unit)

The operation display unit 230 encompasses a function as an operation unit, which is the configuration the proxy P or the candidate C for the proxy operates in order to input the instruction or the information to the proxy's terminal 20, and a function as a display unit, which displays various kinds of information according to the control by the control unit 240.

For example, the operation display unit 230 displays the information about the package L transmitted from the proxy management server 30 to the communication unit 220.

In addition, the operation display unit 230 displays the proxy request by the recipient R, the notification of the proxy recruitment, and the notification of setting of the proxy P that are transmitted from the proxy management server 30 to the communication unit 220. The candidate C for the proxy can also input whether the proxy pick-up of the package L is possible by operating the operation display unit 230.

### (Control Unit)

The control unit 240 controls the overall operation of the proxy's terminal 20. For example, the control unit 240 causes the communication unit 220 to transmit the notification, which is acquired by the operation display unit 230, as to whether the proxy pick-up of the package L is possible. The control unit 240 also causes the operation display unit 230 to display the information about the package L, the proxy request, the notification of the proxy recruitment, the notification of setting of the proxy P, and the like that are received from the proxy management server 30 by the communication unit 220.

### <2-3. Example of Functional Configuration of Proxy Management Server 30>

The example of the functional configuration of the proxy's terminal 20 according to the embodiment of the present invention has been described above. Next, an example of the functional configuration of the proxy management server 30 is described.

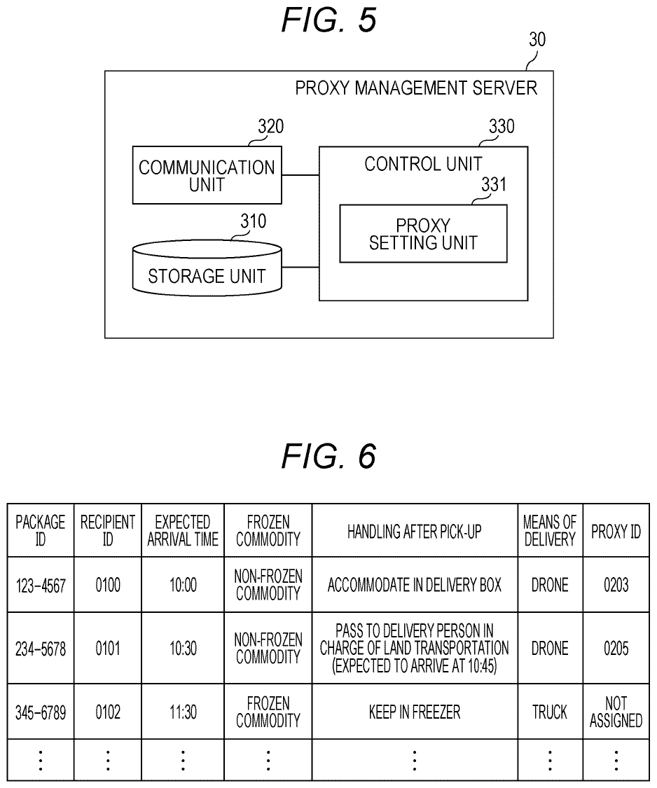

FIG. 5 is an explanatory diagram illustrating an internal structure of the proxy management server 30. As illustrated in FIG. 5, the proxy management server 30 includes a storage unit 310, a communication unit 320, and a control unit 330.

### (Storage Unit)

The storage unit 310 stores therein programs and various kinds of data for operating the control unit 330. For example, the storage unit 310 stores therein recipient information, which is information about the recipient R. The recipient information includes, for example, various basic information such as the name of the recipient R, the recipient name in the service, the recipient ID corresponding to the identification information of the recipient R, e-mail address, address, or phone number, account information for external applications, and payment information (such as credit card information). The storage unit 310 also stores therein one or more candidates C for the proxy set in advance by the recipient R. However, the recipient information is not limited to these items.

The storage unit 310 also stores information about the candidate C for the proxy therein. The information about the candidate C for the proxy includes, for example, the name of the candidate C for the proxy, the name of the candidate C for the proxy in the service, the proxy ID corresponding to the identification information of the candidate C for the proxy, e-mail address, phone number, address, gender, age, external application account information, and the type of the candidate C for the proxy.

Examples of the type of the candidate C for the proxy include a designated candidate for the proxy who picks up the package L as the proxy P only when designated by the particular recipient R as the candidate C for the proxy, a contract candidate for the proxy who contracts for the pick-up of the package L on behalf of the recipient R as a one-off job, and the manager of the predetermined departure and arrival point. If the manager of the predetermined departure and arrival point is stored as the type of candidate C for the proxy, the storage unit 310 may store the address of the predetermined departure and arrival point therein.

The storage unit 310 may also store therein information about the pick-up of the package L by the candidate C for the proxy. The information about the pick-up of the package L includes, for example, information about the status of participation in a predetermined training session related to the means of picking up the package L, the desired pick-up area, identification card information (including driver's license information), transfer account information, proxy pick-up history information, and the like. The predetermined training session related to the means of picking up the package L is, for example, a training session to pick up the package L from an unmanned aircraft.

The storage unit 310 also stores therein the information about the package L where the recipient R is designated in the address using the recipient's terminal 10.

The information about the package L includes, for example, the package ID, which is the identification information of the package L. The information about the package L may include the information about the delivery of the package L, such as the recipient ID of the recipient R of the package L, the delivery destination of the package L, the expected arrival time of the package L, the delivery means of the package L, the delivery method of the package L, and the information about the handling of the picked-up package L. The expected arrival time may be the time according to the delivery time slot that is included in the delivery request transmitted from the recipient's terminal 10. The expected arrival time may be calculated by the control unit 330 on the basis of the time slot of the delivery, which is included in the delivery request transmitted from the recipient's terminal 10.

The delivery method of the package L is information such as unmanned delivery, manned delivery, or contactless delivery, for example. The delivery method of the package L may also include information as to whether the proxy P is required to pick up the package L from the unmanned aircraft.

The information about the handling of the picked-up package L is the information, for example, as to whether the proxy P needs to keep the package, the proxy P passes the picked-up package L to the recipient R, the delivery person, etc. or accommodates the picked-up package L in a delivery box that is installed outdoors and can accommodate the package L, or the cool management (including refrigeration management and freezing management) is necessary while the package is kept.

If the proxy P, after the pick-up, needs to pass the package L to the recipient R, the delivery person, etc., the information about the handling of the package L after the pick-up may include the expected arrival time of the recipient R or the delivery person. The expected arrival time of the recipient R or the delivery person may be transmitted to the communication unit 320 from the recipient's terminal 10 used by the recipient R or the information processing terminal used by the delivery person.

If the proxy P, after the pick-up, needs to pass the package L to the recipient R or the delivery person, etc., the information about the handling of the package L after the pick-up may include the meeting place with the recipient R or the delivery person. The meeting place with the recipient R or the delivery person may be transmitted to the communication unit 320 from the recipient's terminal 10 used by the recipient R or the information processing terminal used by the delivery person.

The information about the package L includes the information about the characteristic of the package L, for example, the size and weight of the package L, whether the package L is a frozen commodity, and whether the package L is a commodity that needs to be handled with care. The commodity that needs to be handled with care may be at least any of “this side up”, “do not stack”, “perishable item”, and “fragile”.

The information about the package L also includes the proxy ID of the proxy P who can pick up the package L by proxy.

FIG. 6 is a diagram illustrating an example of the information about the package L that is stored in the storage unit 310. In the example illustrated in FIG. 6, the recipient ID, the expected arrival time, whether the package is a frozen commodity, the information about the handling after the pick-up, the delivery means, and the proxy ID that are linked to the package ID of each package L are expressed. The communication unit 320 notifies the proxy's terminal 20 of the information about the package L on the basis of the information about the package L that is stored in the storage unit 310.

The storage unit 310 may also store therein an instruction for the proxy P according to the information about the package L. For example, the storage unit 310 may store therein an instruction for the preparation to be performed by the proxy P according to the delivery means of the package L. More specifically, the delivery means of the package L being the unmanned vehicle may be stored while being linked to the instruction of the preparation for accepting the unmanned vehicle (for example, a landing preparation by preparing a landing mattress or a proportional controller, checking of a pick-up device, etc.). The storage unit 310 may also store therein the fact that the package L is a frozen commodity and an instruction to check a freezer space while linking these pieces of information.

### (Communication Unit)

The communication unit 320 communicates with the recipient's terminal 10 and the proxy's terminal 20 via the network 50. The communication unit 320 notifies the recipient's terminal 10 of the information, thereby notifying the recipient R who uses the recipient's terminal 10 of the information. By notifying the proxy's terminal 20 of the information, the communication unit 320 notifies the proxy P who uses the proxy's terminal 20 or the candidate C for the proxy of the information.

The communication unit 320 receives the delivery request, the designation information, and the proxy request from the recipient's terminal 10. The communication unit 320 also transmits to the recipient's terminal 10, the setting status of the proxy P about the package L where the recipient R is designated in the address and the notification as to whether the delivery of the package L is possible, etc.

### The Communication Unit 320 Also Notifies the Proxy's

terminal 20 used by the proxy P or the candidate C for the proxy of the information stored in the storage unit 310 about the package L.

The communication unit 320 may also notify the proxy's terminal 20 used by the proxy P of the preparation instruction that is linked to the information about the package L. For example, if the delivery means of the package L is the unmanned vehicle, the communication unit 320 may notify the proxy P so as to perform the landing preparation of the unmanned vehicle.

The communication unit 320 also transmits the proxy request, the notification of the proxy recruitment, and the notification of setting of the proxy P to the proxy's terminal 20. The communication unit 320 receives the notification from the proxy's terminal 20 as to whether the proxy pick-up of the package L is possible.

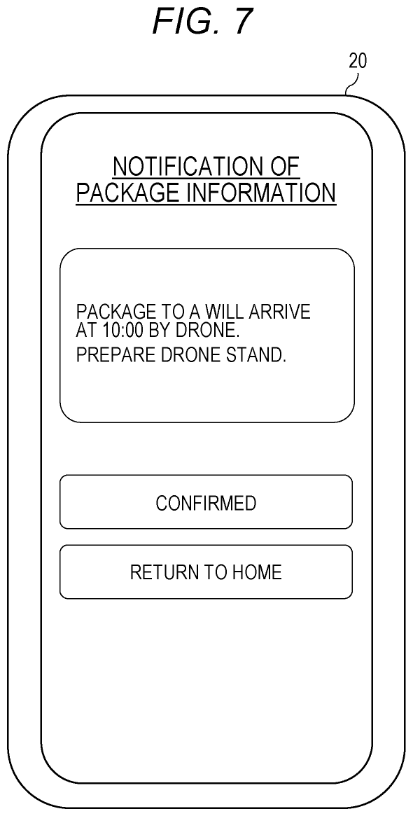

Here, with reference to FIG. 7 to FIG. 9, examples of the notifications of the information about the package L to be notified to the proxy's terminal 20 are described. FIG. 7 is a diagram illustrating an example of the notification of the information about the package L to the proxy P when the information about the package L illustrated in FIG. 6 is stored in the storage unit 310. In the example illustrated in FIG. 7, the recipient information stored in the storage unit 310 expresses that the name of the recipient R with the recipient ID “0100” is A.

The communication unit 320 notifies the proxy's terminal 20 used by the proxy P whose proxy ID is “0203” of the information about the package L whose package ID is “123-4567”. The storage unit 310 stores therein that the expected arrival time is 10:00 and the delivery means of the package L addressed to the recipient R, whose recipient ID is “0100”, is a drone, which is an unmanned vehicle. Therefore, the communication unit 320 notifies that the package L addressed to A is scheduled to arrive at 10:00, as well as instructions to prepare for accepting the unmanned aircraft, such as preparing a landing site or a proportional controller (preparation of landing assistance), which is an example of the landing preparation for the unmanned vehicle.

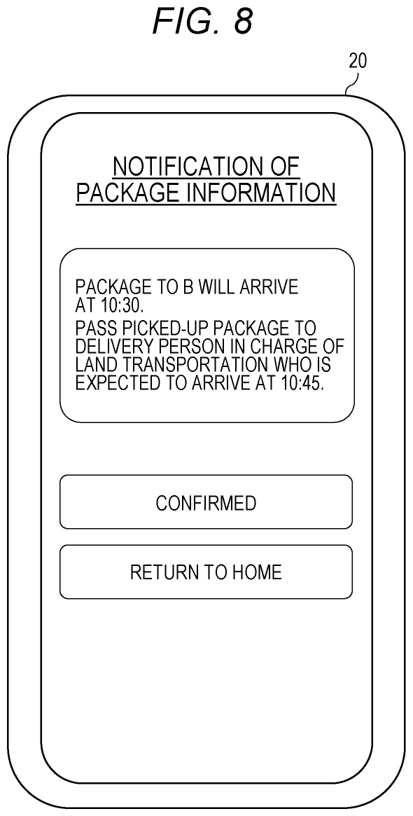

FIG. 8 is a diagram illustrating an example of the notification of the information about the package L to the proxy P when the information about the package L illustrated in FIG. 6 is stored in the storage unit 310. In the example illustrated in FIG. 8, the recipient information stored in the storage unit 310 expresses that the name of the recipient with the recipient ID “0101” is B.

The communication unit 320 notifies the proxy's terminal 20 used by the proxy P whose proxy ID is “0205” of the information about the package L whose package ID is “123-4567”. The storage unit 310 stores therein that the expected arrival time is 10:30, and in the information about the handling of the picked-up package L of the recipient R with the recipient ID “0101”, it is necessary to pass the picked-up package L to a delivery person in charge of the land transportation and the expected arrival time of the delivery person is 10:45. Therefore, the communication unit 320 notifies that the package L addressed to B is scheduled to arrive at 10:00, that the package L needs to be handed over to the delivery person in charge of the land transportation, and that the expected arrival time of the delivery person is 10:45. In this way, the proxy P can smoothly pick up the package by checking in advance the notification of the information about the package L transmitted from the proxy management server 30.

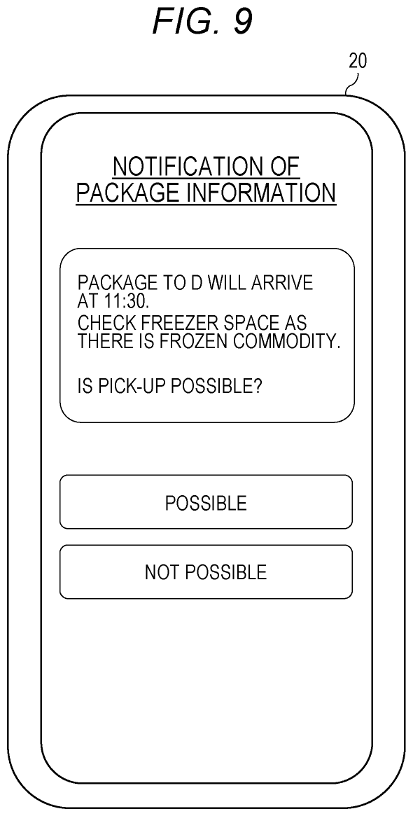

FIG. 9 is a diagram illustrating an example of the notification of the information about the package L to the candidate C for the proxy when the information about the package illustrated in FIG. 6 is stored in the storage unit 310. In the example illustrated in FIG. 9, the recipient information stored in the storage unit 310 expresses that the name of the recipient with the recipient ID “0102” is D.

The communication unit 320 notifies the proxy's terminal 20 used by the candidate C for the proxy of the information about the package L whose package ID is “345-6789”. The storage unit 310 stores therein that the expected arrival time is 11:30 and the package L of the recipient R whose recipient ID is “0102” is a frozen commodity. Therefore, the communication unit 320 notifies the proxy's terminal 20 of the instruction to check the freezer space. The candidate C for the proxy can also transmit the notification that the pick-up of the package L is possible or impossible to the proxy management server 30 by selecting a pick-up possible button or a pick-up impossible button displayed on the proxy's terminal 20. Thus, the candidate C for the proxy can determine whether the pick-up is possible by checking the notification of the information about the package L transmitted from the proxy management server 30.

### (Control Unit)

The control unit 330 controls the overall operation of the proxy management server 30. For example, the control unit 330 controls so that the information received from the recipient's terminal 10 and the proxy's terminal 20 by the communication unit 320 is stored in the storage unit 310.

In the present embodiment, the control unit 330 has a function as a proxy setting unit 331.

### (Proxy Setting Unit)

The proxy setting unit 331 sets the proxy P in accordance with the information received from the recipient's terminal 10 or the proxy's terminal 20 by the communication unit 320 or the information about the package L.

The proxy setting unit 331 also controls the communication unit 320 so as to notify the recipient's terminal 10 of the information on the basis of the setting status of the proxy P. For example, the proxy setting unit 331 may control the communication unit 320 so as to notify the recipient R that the delivery of the package L is impossible if the proxy P who can pick up the package L cannot be set. If the proxy P who can pick up the package L cannot be set, the proxy setting unit 331 may control the communication unit 320 so as to notify the recipient R and request resetting of the delivery time slot and the delivery destination of the package L, and the type of the proxy.

The setting operation of the proxy P by the proxy setting unit 331 is described in detail here.
Setting of the proxy P when the designation information about the package L is received from the recipient's terminal 10

First, the setting operation of the proxy P when the designation information about the package L is received from the recipient's terminal 10 by the communication unit 320 is described.

When the communication unit 320 receives the designation information, which is the designation of the candidate C for the proxy, about the package L from the recipient's terminal 10, the proxy setting unit 331 controls the communication unit 320 so as to transmit the proxy request to ask for the proxy pick-up of the package L to the proxy's terminal 20 used by the candidate C for the proxy.

When the communication unit 320 receives the notification that the candidate C for the proxy that is set in advance is designated as the candidate C for the proxy about the package L from the recipient's terminal 10, the proxy setting unit 331 controls the communication unit 320 so as to transmit the proxy request to the proxy's terminal 20 used by the candidate C for the proxy. The proxy request may include the notification of the information about the package L. When the communication unit 320 receives the notification that the pick-up of the package L is possible from the proxy's terminal 20 to which the proxy request has been transmitted, the proxy setting unit 331 sets the candidate C for the proxy who uses the proxy's terminal 20, as the proxy P. This enables the recipient R to have a specific person pick up the package L on his/her behalf.
Setting of the proxy P when the proxy support request about the package L is received from the recipient's terminal 10

Next, the setting operation of the proxy P when the proxy support request about the package L is received by the communication unit 320 from the recipient's terminal 10 is described.

When the communication unit 320 receives the proxy support request by the recipient R regarding the package L from the recipient's terminal 10, the proxy setting unit 331 selects the candidate C for the proxy. The proxy setting unit 331 may select the candidate C for the proxy who picks up the package L by proxy according to the positional information of the candidate C for the proxy received from the proxy's terminal 20 by the communication unit 320.

The proxy setting unit 331 may select the candidate for the proxy who picks up the package L by proxy with reference to the information about the package L and the information about the candidate C for the proxy that are stored in the storage unit 310. For example, in a case where the storage unit 310 stores therein the information in which the proxy P picking up the package L from the unmanned aircraft is designated as the means of pick-up, the proxy setting unit 331 may select the candidate for the proxy stored in the storage unit 310 as the person who has taken the predetermined training session related to the means of picking up the package L, as the candidate for the proxy about the package L.

The proxy setting unit 331 controls the communication unit 320 so as to transmit the notification of the proxy recruitment to the proxy's terminal 20 used by the selected candidate C for the proxy. The notification of the proxy recruitment may include the notification of the information about the package L. The candidate C for the proxy can determine whether to pick up the package L by proxy by checking the information about the package L.

The notification of the proxy recruitment may include reward information. The reward information is information about the reward that the candidate C for the proxy, as the proxy P, can obtain by picking up the package L on behalf of the recipient R. The reward may be money, a service, or points of monetary value, etc. The content of the reward may be determined by the recipient R who uses the recipient's terminal 10 that transmitted the proxy support request, or may be a predetermined content.

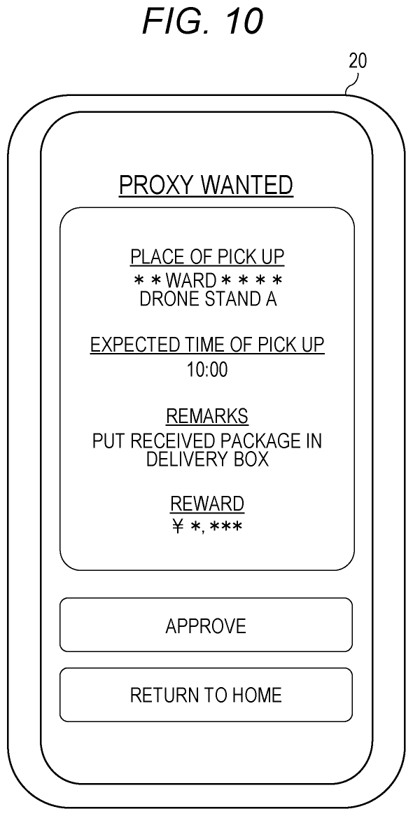

FIG. 10 is a diagram illustrating an example of the notification of the proxy recruitment transmitted to the proxy's terminal 20. As illustrated in FIG. 10, the notification of the proxy recruitment includes information such as the pick-up position of the package L, the expected pick-up time, an action after the pick-up, and reward, which are the information about the package L. The candidate C for the proxy can also transmit the notification to the proxy management server 30 that the proxy pick-up of the package L is possible by selecting an approval button displayed on the proxy's terminal 20. This allows the recipient R to have someone pick up the package L on his/her behalf, even if there is no specific person the recipient R can ask to pick up the package L on his/her behalf.

When the communication unit 320 receives the notification that the pick-up of the package L is possible from the proxy's terminal 20 to which the notification of the proxy recruitment has been transmitted, the proxy setting unit 331 sets the candidate for the proxy who uses the proxy's terminal 20, as the proxy P. The proxy setting unit 331 may select a plurality of the candidates C for the proxy. In that case, the proxy setting unit 331 may control the communication unit 320 so as to simultaneously transmit the notification of the proxy recruitment to the proxy's terminals 20 used by the selected candidates C for the proxy. The proxy setting unit 331 may set as the proxy P, the candidate C for the proxy who uses the proxy's terminal 20 to which the notification that the proxy pick-up of the package L is possible is transmitted first.

The proxy setting unit 331 may also control to transmit the notification of the proxy recruitment to one or more candidates C for the proxy among the selected candidates C for the proxy. In that case, when the communication unit 320 receives the notification that the pick-up of the package L is impossible from the proxy's terminal 20 to which the notification of the proxy recruitment has been transmitted, the proxy setting unit 331 controls the communication unit 320 so as to transmit the proxy recruitment to another candidate C for the proxy who is different from the candidate C for the proxy who uses the proxy's terminal 20.
Setting of proxy P on the basis of information about package L The example in which the proxy P is set based on the information received from the recipient's terminal 10 has been described. Subsequently described is an example in which the proxy P is set based on the information about the package L.

The proxy setting unit 331 selects the candidate C for the proxy on the basis of the information about the package L that is stored in the storage unit 310. For example, the proxy setting unit 331 may refer to the delivery destination of the package L included in the information about the package L that is stored in the storage unit 310 and select, as the candidate C for the proxy about the package L, the manager of the departure and arrival point that is closest to the delivery destination among predetermined departure and arrival points. The proxy setting unit 331 controls the communication unit 320 so as to transmit the notification of the proxy recruitment to the proxy's terminal 20 used by the selected candidate C for the proxy.

When the communication unit 320 receives the notification that the pick-up of the package L is possible from the proxy's terminal 20 to which the notification of the proxy recruitment has been transmitted, the proxy setting unit 331 sets the candidate for the proxy who uses the proxy's terminal 20, as the proxy P. On the other hand, when the communication unit 320 receives the notification that the pick-up of the package L is impossible from the proxy's terminal 20 to which the notification of the proxy recruitment has been transmitted, the proxy setting unit 331 controls the communication unit 320 so as to transmit the notification of the proxy recruitment to the candidate C for the proxy that is different from the candidate for the proxy who uses the proxy's terminal 20. The newly selected candidate C for the proxy may be the manager of the next closest departure and arrival point to the departure and arrival point managed by the candidate C for the proxy who transmits the notification that the pick-up of the package L is impossible, among the predetermined departure and arrival points. The proxy setting unit 331 keeps controlling the notification of the proxy recruitment and the selection of the candidate C for the proxy about the package L until the notification that the pick-up of the package L is possible is transmitted or the notification that the pick-up of the package L is impossible is transmitted from all the managers in the departure and arrival points within a predetermined distance from the delivery destination of the package L.

The proxy setting unit 331 may set the candidate C for the proxy without issuing notification of the proxy recruitment on the basis of the information about the package L that is stored in the storage unit 310. For example, the proxy setting unit 331 may set the proxy P on the basis of the information about the package L included in the delivery request received by the communication unit 320 from the recipient's terminal 10. For example, if the delivery request received by the communication unit 320 from the recipient's terminal 10 includes the pick-up position of the package L, the manager of the predetermined departure and arrival point at that position may be set as the proxy P.

### 3. Example of Operation Processing in Present Embodiment

The examples of the functional configurations in the present embodiment according to the embodiment of the invention have been described above. Subsequently, an example of operation processing according to the present embodiment is described.

Here, the recipient R, the candidate C for the proxy, and the proxy P, provided by the present information processing system, access the proxy management server 30 using an application (including a web browser) or the like, and if they use the service for the first time, they may log in the service through a registration process. If the user already has an account, the user may be able to use the service by logging in after prescribed authentication, for example, by entering the user ID or recipient ID and a password. Instead of the account, a unique application ID related to the application downloaded on the recipient's terminal 10 or the proxy's terminal 20 may be used as the user ID or the recipient ID to enable the service use.

After this login authentication, the service use is initiated via the application (including web browser), etc.

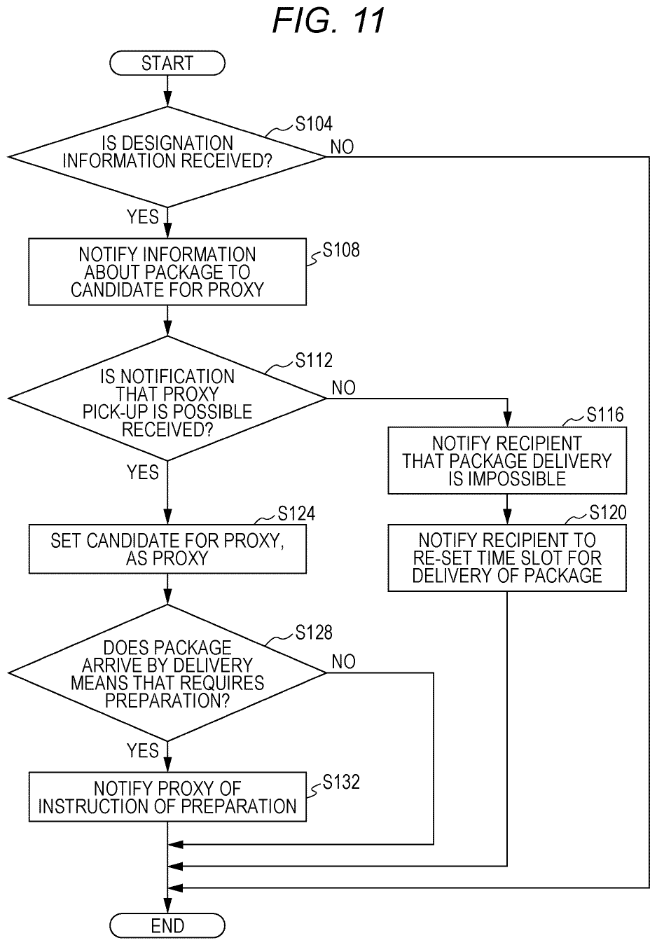

FIG. 11 is an explanatory diagram for describing an example of the procedure of the operation processing by the proxy management server 30 according to the present embodiment. First, upon the reception of the designation information, which is the designation of the candidate C for the proxy, from the recipient's terminal 10 (Yes at S104), the communication unit 320 transmits the proxy request including the notification of the information about the package L to the proxy's terminal 20 used by the designated candidate C for the proxy (S108). On the other hand, if the communication unit 320 does not receive the proxy request from the recipient's terminal 10 (No at S104), the proxy management server 30 terminates the process.

After the proxy request is transmitted to the proxy's terminal 20, the proxy setting unit 331 determines whether the communication unit 320 receives the notification that the proxy pick-up is possible from the proxy's terminal 20 (S112). Upon the reception of the notification that the proxy pick-up is impossible from the proxy's terminal 20 (No at S112), the communication unit 320 transmits the notification that the proxy pick-up by the candidate C for the proxy is impossible, to the recipient's terminal 10 used by the recipient R (S116). The communication unit 320 subsequently notifies the recipient's terminal 10 used by the recipient R of the resetting of the time slot for the delivery of the package L (S120).

If the communication unit 320 receives the notification that the proxy pick-up is possible from the proxy's terminal 20 (Yes at S112), the proxy setting unit 331 sets the candidate C for the proxy as the proxy P (S124). If the storage unit 310 stores therein that the package L arrives by the delivery means that requires preparation (Yes at S128), the communication unit 320 notifies the proxy's terminal 20 of the instruction of the preparation to be performed by the proxy P (S132). If the storage unit 310 does not store therein that the package L arrives by the delivery means that requires preparation (No at S128), the proxy management server 30 terminates the process.

### 4. Example of Hardware Configuration

The information processing described above is achieved through cooperation between software and hardware of the proxy management server 30 to be described below. The hardware configuration to be described below is also applicable to the recipient's terminal 10 and the proxy's terminal 20.

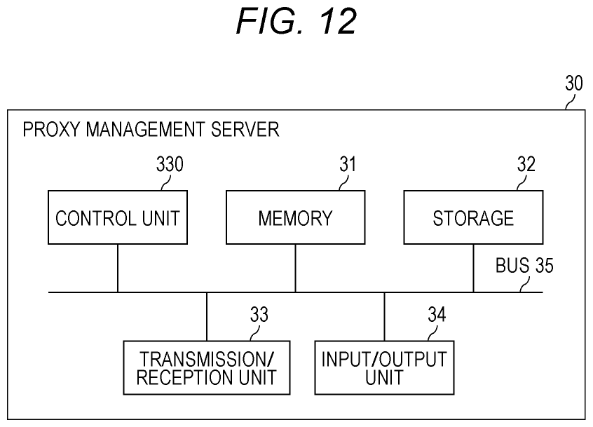

FIG. 12 is an explanatory diagram for describing an example of the hardware configuration of the proxy management server 30 according to the present embodiment.

The proxy management server 30 includes the control unit 330, a memory 31, a storage 32, a transmission/reception unit 33, an input/output unit 34, and the like, which are electrically connected to each other through a bus 35 as illustrated in FIG. 12, for example.

The control unit 330 is an arithmetic unit that controls the overall operation of the proxy management server 30, controls the transmission and reception of data between the components, performs information processing necessary for the application execution and the authentication process, and so on. For example, the control unit 330 is a central processing unit (CPU) and/or a graphics processing unit (GPU), which executes programs for this system stored in the storage 32 and developed in the memory 31, for example, to perform various kinds of information processing as described above.

The memory 31 includes a main memory, which is composed of a volatile storage device such as dynamic random access memory (DRAM), and a secondary memory, which is composed of a non-volatile storage device such as a flash memory or a hard disc drive (HDD). The memory 31 is used as a work area for the control unit 330, for example, and also stores therein the basic input/output system (BIOS), which is executed when the proxy management server 30 is started, various kinds of setting information, and the like.

The storage 32 stores various programs such as application programs. The database storing the data used for each process may be constructed in the storage 32.

The transmission/reception unit 33 connects the proxy management server 30 to a network and/or a blockchain network. The transmission/reception unit 33 may include a short-range communication interface such as Bluetooth (registered trademark) and Bluetooth low energy (BLE).

The input/output unit 34 corresponds to an information input device such as a keyboard, a microphone, or a mouse, or an output device such as a display or a speaker.

The bus 35 is commonly connected to each of the above-described components and transmits, for example, address signals, data signals, and various control signals.

### 4. Supplement

The preferred embodiments of the present invention have been described above in detail with reference to the accompanying drawings; however, the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

In the example described in the present embodiment, the notification as to whether the pick-up of the package L is possible is transmitted from the proxy's terminal 20 with respect to the proxy request or the proxy recruitment; however, the present invention is not limited to this example. In another example, the proxy's terminal 20 may notify that it is not possible for the candidate C for the proxy who uses the proxy's terminal 20 to pick up the package L but it is possible to rent the predetermined departure and arrival point managed by the candidate C for the proxy as the pick-up place. In this case, the proxy setting unit 331 selects another candidate C for the proxy who contracts for the pick-up of the package L on behalf of the recipient R at the departure and arrival point as a one-off job. The proxy setting unit 331 sets the proxy P by issuing notification of the selected candidate C for the proxy of the proxy recruitment. According to such a structure, even in a case where the package L arrives by the means that can arrive at the limited place, such as an unmanned vehicle, and the proxy pick-up by the manager of that place is impossible, the proxy P who is different from the manager can pick up the package L. That is to say, according to such a structure, the smooth pick-up of the package L by the proxy P who is a representative of the recipient R can be realized.

In addition, it is also possible to create a computer program to make the hardware such as a CPU, a ROM, and a RAM incorporated in the proxy management server 30 achieve the functions equivalent to the respective structures of the proxy management server 30 describe above.

### REFERENCE SIGNS LIST

10 Recipient's terminal
20 Proxy's terminal
30 Proxy management server
50 Network
110 Communication unit
120 Operation display unit
130 Control unit
210 Sensor unit
220 Communication unit
230 Operation display unit
240 Control unit
310 Storage unit
320 Communication unit
330 Control unit
331 Proxy setting unit

1. An information processing system comprising:
a control unit that sets a candidate for a proxy who is able to pick up a package on behalf of a recipient designated in an address of the package, as the proxy; and
a communication unit that notifies the proxy or the candidate for the proxy of information about the package.

2. The information processing system according to claim 1, wherein the communication unit notifies the proxy or the candidate for the proxy of an expected arrival time of the package.

3. The information processing system according to claim 2, wherein the communication unit notifies the proxy or the candidate for the proxy of the expected arrival time of the package according to a time slot of delivery of the package.

4. The information processing system according to claim wherein the communication unit receives an expected arrival time of the recipient from an information processing terminal used by the recipient, and notifies the proxy of the expected arrival time.

5. The information processing system according to claim 1, wherein in a case where the package picked up by the proxy is delivered to the recipient by a delivery person, the communication unit notifies the proxy or the candidate for the proxy of an expected arrival time of the delivery person.

6. The information processing system according to claim 1, wherein the communication unit notifies the proxy or the candidate for the proxy whether the package is a frozen commodity.

7. The information processing system according to claim 1, wherein the communication unit notifies the proxy or the candidate for the proxy of whether the package is a commodity that needs to be handled with care.

8. The information processing system according to claim 7, wherein the commodity that needs to be handled with care is at least any of “this side up”, “do not stack”, “perishable item”, or “fragile”.

9. The information processing system according to claim 1, wherein the communication unit notifies the proxy of a delivery means of the package.

10. The information processing system according to claim 9, wherein the communication unit notifies the proxy of an instruction of preparation in accordance with the delivery means of the package.

11. The information processing system according to claim 10, wherein in a case where the delivery means of the package is an unmanned vehicle, the communication unit notifies the proxy to perform landing preparation of the unmanned vehicle.

12. The information processing system according to claim 1, wherein the communication unit receives a notification as to whether pick-up of the package is possible, from an information processing terminal used by the candidate for the proxy.

13. The information processing system according to claim 12, wherein when the communication unit receives a notification that the pick-up of the package is impossible from the information processing terminal used by the candidate for the proxy, the communication unit transmits a proxy recruitment for package pick-up to a candidate for the proxy who is different from the candidate for the proxy.

14. The information processing system according to claim 13, wherein in a case where setting of the proxy who is able to pick up the package is impossible, the communication unit notifies the recipient that the delivery of the package is impossible.

15. The information processing system according to claim 13, wherein in a case where setting of the proxy who is able to pick up the package is impossible, the communication unit notifies the recipient to reset the time slot of the delivery of the package.

16. An information processing device comprising:
a control unit that sets a candidate for a proxy who is able to pick up a package on behalf of a recipient designated in an address of the package, as the proxy; and
a communication unit that notifies the proxy or the candidate for the proxy of information about the package.

17. An information processing method to be performed by a computer, the information processing method comprising:
setting a candidate for a proxy who is able to pick up a package on behalf of a recipient designated in an address of the package, as the proxy; and
notifying the proxy or the candidate for the proxy of information about the package.

18. A program causing a computer to function as:
a control unit that sets a candidate for a proxy who is able to pick up a package on behalf of a recipient designated in an address of the package, as the proxy; and
a communication unit that notifies the proxy or the candidate for the proxy of information about the package.
